(19) United States
(12) Patent Application Publication
(10) Pub. No.: US 2006/0196461 A1
(43) Pub. Date: Sep. 7, 2006

(54) Starter motor for motor vehicle engine

(76) Inventor: Ali R. Abolfathi, Edmonton (CA)

Correspondence Address: DAVIS & BUJOLD, P.L.L.C., 112 PLEASANT STREET, CONCORD, NH, 03301, US

(21) Appl. No.: 11/362,382

(22) Filed: Feb. 23, 2006

(30) Foreign Application Priority Data
Mar. 7, 2005 (CA) 2,500,602

(51) Int. Cl. F02N 11/00

(52) U.S. Cl. 123/179.25

(57) ABSTRACT

A starter motor for a motor vehicle engine includes, in combination, a first electric motor adapted to operate on direct current power supplied from a battery and a second electric motor adapted to operate on alternating current power supplied from an electrical outlet. The first electric motor and the second electric motor are connected in tandem with a common output shaft. When insufficient power is supplied from the battery to the first electric motor to start the motor vehicle engine, the second electric motor is temporarily connected to the electrical outlet and the second electric motor used to start the motor vehicle engine.

This application claims priority from Canadian Application Serial No. 2,500,602 filed Mar. 7, 2005.

### FIELD OF THE INVENTION

The present invention relates to a starter motor, which is used to start a motor vehicle engine.

### BACKGROUND OF THE INVENTION

Every year millions of driver have to call upon their local automobile associations for a “boost”, when they are unable to start their motor vehicles due to a battery failure or a failure of a charging system, which charges the battery.

### SUMMARY OF THE INVENTION

According to the present invention there is provided a starter motor for a motor vehicle engine. The starter motor includes, in combination, a first electric motor adapted to operate on direct current power supplied from a battery and a second electric motor adapted to operate on alternating current power supplied from an electrical outlet. Means are provided for temporarily connecting the second electric motor to the electrical outlet. The first electric motor and the second electric motor are connected in tandem with a common output shaft. When insufficient power is supplied from the battery to the first electric motor to start the motor vehicle engine, the second electric motor is temporarily connected to the electrical outlet and the second electric motor used to start the motor vehicle engine.

It will be appreciated that the second electric motor of the above described starter motor will only be able to start the motor vehicle engine if there is an electrical outlet nearby from which power may be obtained. However, in a majority of cases, a disabled automobile in need of a “boost” is in close proximity to an electrical outlet. Often the disabled automobile is parked in the owner's driveway.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a motor vehicle engine equipped with a starter motor constructed in accordance with the teachings of the present invention.

FIG. 2 is a first embodiment starter motor constructed in accordance with the teachings of the present invention.

FIG. 3 is a second embodiment of starter motor in accordance with the teachings of the present invention.

### DETAILED DESCRIPTION OF THE PREFERRED EMBODIMENT

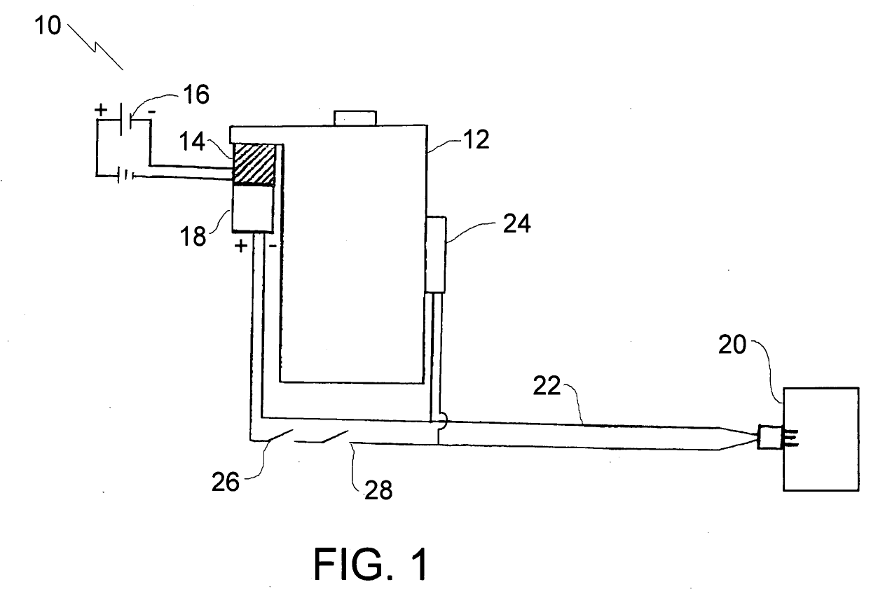

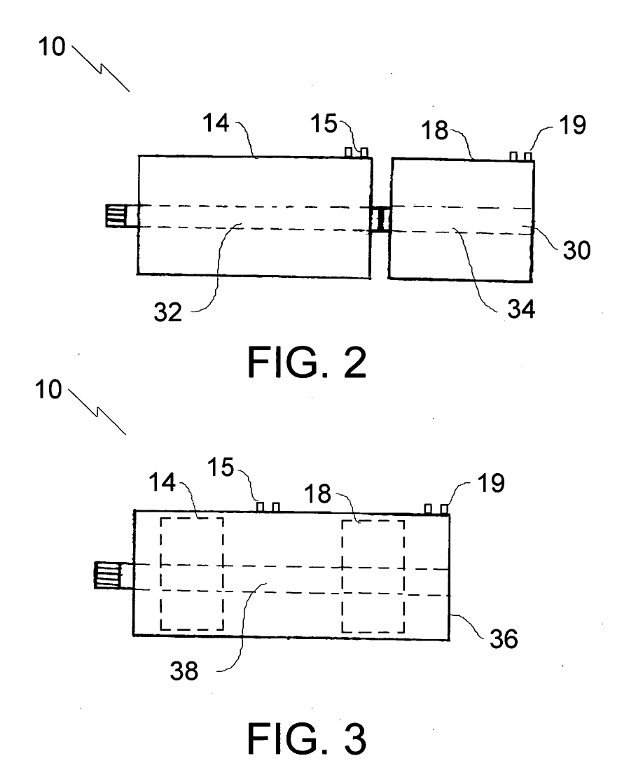

A first embodiment of starter motor generally identified by reference numeral 10, will now be described with reference to FIGS. 1 and 2. A second embodiment of starter motor generally identified by reference numeral 100, will now be described with reference to FIGS. 1 and 3.

Structure and Relationship of Parts:

Referring to FIG. 1, starter motor 10 for a motor vehicle engine 12 includes a first electric motor 14 adapted to operate on direct current power supplied from a battery 16, such as a 12 V. battery as is common in motor vehicles. There is a second electric motor 18 adapted to operate on alternating current power supplied from an electrical outlet 20, such as a 120 V as is common for outlets. A power cord 22 permits second electric motor 18 to be temporarily connected to electrical outlet 20, although other means of connecting the two may be used. For convenience, cord 22 may also be the cord that is used to supply power to an engine block heater 24, if present. There is a switch 26 to supply power to second electric motor 18, as well as a starting switch 28, to cause second motor 18 to operate. These switches are shown in series to represent the fact that both must be closed for second electric motor 18 to operate. If cord 22 does not supply power to block heater 24, only starting switch 28 will be needed. Starting switch is closed when the motor vehicle is being started, for example, when the key is turned.

Referring to FIG. 2, first electric motor 14 has terminals 15 to connect to battery 16 and second electric motor 18 has terminals 19 to connect to an electrical outlet. First electric motor 14 and second electric motor 18 are connected in tandem with a common output shaft 30. When insufficient power is supplied from battery 16 to first electric motor 14 to start motor vehicle engine 12, second electric motor 18 is temporarily connected to electrical outlet 20 and second electric motor 18 is used to start motor vehicle engine 12. As depicted, common shaft is composed of a first shaft portion 32 in first electric motor 14 connected to a second shaft portion 34 in second electric motor 18. This connection may be made by welding or other coupling.

Operation:

The use and operation of starter motor 10 will now be discussed with reference to FIGS. 1 and 2. Starter motor 10 is connected to motor vehicle engine 12 as shown in FIG. 1. In most circumstances, first electric motor 14 will be used to start engine 12. However, if first electric motor 14 is unable to start motor vehicle engine 12, for example, if battery 16 is dead, due to lights in a vehicle being left on, or in cold weather, second electric motor 18 is temporarily connected to electrical outlet 20 by power cord 22. Switch 26 is closed, and starting switch 28 is then closed while an attempt to start engine 12 is made.

Variations:

Referring to FIG. 3, starter motor 100 is arranged in a similar manner to starter motor 10 described above. However, in this embodiment, first electric motor 14 and second electric motor 18 are combined in one housing 36 on a single shaft 38.

Advantages:

Just as a block heater is activated by 120 volt electricity, the starter motors described above can be connected in parallel to the wiring of the block heater and used at the same time. Cold winters, weak batteries, fuel injection problems, and many other problems which now require one to call and pay for a “boost”, can be solved by pulling in the starter motor and turning the key. In most, if not all, makes of automobiles there is enough room behind the main starter for another starter which is not more than 10 to 12 inches long. The main shafts of the first electric motor 14 and second electric motor 18 can be joined in many ways and is not critical to the invention. It is envisaged that eventually a single starter will be commercially available that has dual functions, which involves the integration of a 12 volt electric motor and a 120 volt electric motor on a single shaft with two power input 12 volt and 120 volt. This would enable a “normal” starter to be replaced by a dual function one, as described above, if desired or if the normal starter should fail.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the Claims.

What is claimed is:

1. A starter motor for a motor vehicle engine, comprising in combination:
a first electric motor adapted to operate on direct current power supplied from a battery;
a second electric motor adapted to operate on alternating current power supplied from an electrical outlet;
means for temporarily connecting the second electric motor to the electrical outlet;
the first electric motor and the second electric motor being connected in tandem with a common output shaft, such that when insufficient power is supplied from the battery to the first electric motor to start the motor vehicle engine, the second electric motor is temporarily connected to the electrical outlet and the second electric motor used to start the motor vehicle engine.

2. The starter motor as defined in claim 1, wherein the battery supplies 12 volt power.

3. The starter motor as defined in claim 1, wherein the electrical outlet supplies 120 volt power.
